(19) United States
(12) Patent Application Publication
(10) Pub. No.: US 2013/0049423 A1
(43) Pub. Date: Feb. 28, 2013

(54) ADJUSTABLE VEHICLE SEAT HEAD RESTRAINT ASSEMBLY

(71) Applicants: Stefan Brunner, Freising (DE); Achim Tscherbner, Ingolstadt (DE)

(72) Inventors: Stefan Brunner, Freising (DE); Achim Tscherbner, Ingolstadt (DE)

(73) Assignee: LEAR CORPORATION, Southfield, MI (US)

(21) Appl. No.: 13/596,455

(22) Filed: Aug. 28, 2012

(30) Foreign Application Priority Data
Aug. 29, 2011 (DE) 10 2011 081 737.9

(51) Int. Cl. B60N 2/48; B60N 2/20

(52) U.S. Cl. 297/354.1; 297/391

(57) ABSTRACT

An adjustable head restraint assembly is provided with a guide that is mounted to a seat back frame of a vehicle seat. A head restraint extends from the seat back and is mounted to the guide for translation along the guide. A suspension cooperated with the guide and the head restraint for biasing the head restraint to an extended position. A locking mechanism maintains the head restraint in a retracted position.

### CROSS-REFERENCE TO RELATED APPLICATIONS

This application claims foreign priority benefits under 35 U.S.C. §119(a)-(d) to DE 10 2011 081 737.9, filed Aug. 29, 2011, the disclosure of which is hereby incorporated by reference in its entirety.

### TECHNICAL FIELD

Various embodiments relate to adjustable head restraint assemblies for vehicle seats.

### BACKGROUND

The prior art has offered various adjustable head restraint assemblies for vehicle seats. One such example is described in U.S. Pat. No. 7,922,252 B2, which issued on Apr. 12, 2011 to Brunner.

### BRIEF DESCRIPTION OF THE DRAWINGS

FIG. 1 is a front elevation view of a vehicle seat according to an embodiment;

FIG. 2 is an enlarged elevation view of an adjustable head restraint assembly of the vehicle seat of FIG. 1, illustrated in an upright position of a seat back of the vehicle seat of FIG. 1, and in a locked extended position of the adjustable head restraint assembly;

FIG. 3 is another enlarged elevation view of the adjustable head restraint assembly of FIG. 2, illustrated in an intermediate position of the seat back, and in an unlocked intermediate position of the adjustable head restraint assembly;

FIG. 4 is another enlarged elevation view of the adjustable head restraint assembly of FIG. 2, illustrated in a folded position of the seat back, and in a locked retracted position of the adjustable head restraint assembly;

FIG. 5 is another enlarged elevation view of the adjustable head restraint assembly of FIG. 2, illustrated in an upright position of the seat back, and in a locked retracted position of the head restraint assembly;

FIG. 6 is a schematic of a cable assembly of the vehicle seat of FIG. 1, illustrated in the upright position of the vehicle seat; and

FIG. 7 is another schematic of the cable assembly of FIG. 6, illustrated in the folded position of the vehicle seat.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

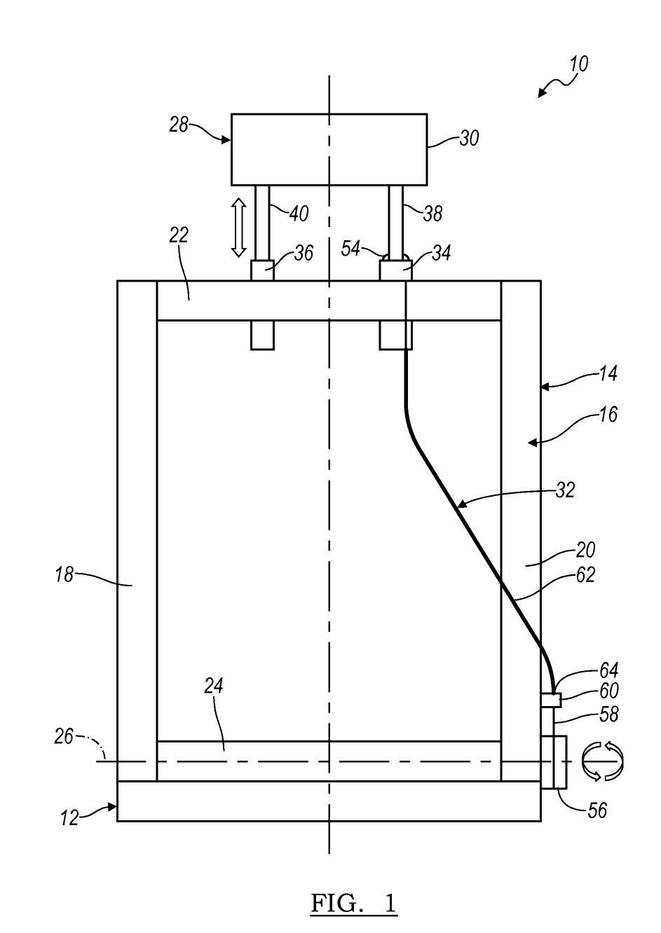

Referring now to FIG. 1, a vehicle seat is illustrated and referenced generally by numeral 10. The vehicle seat 10 has a seat bottom 12 for supporting an occupant. A seat back 14 is mounted in the vehicle to pivot relative to the seat bottom 12. The seat back 14 is for supporting a back of an occupant. The seat back 14 in the depicted embodiment is pivotally supported by the seat bottom 12. Of course, the seat back 14 may be pivotally supported by the vehicle body. The seat back 14 pivots relative to the seat bottom 12 for folding the seat back 14. Therefore, the vehicle seat 10 may be employed as a folding seat for permitting ingress and egress to seats rearward of the vehicle seat 10. Alternatively, the vehicle seat 10 may be a collapsible seat, such as a rear row seat that can be collapsed for stowage or removal.

The seat back 14 has a frame 16 with a pair of spaced apart side members 18, 20 interconnected by an upper cross member 22 and a lower cross member 24. The frame 16 is illustrated having a pivot axis 26 for pivoting relative to the seat bottom 12. The vehicle seat 10 includes an adjustable head restraint assembly 28 supported upon the upper cross member 22 of the seat back frame 16. The head restraint assembly 28 includes a head restraint 30 extended above the seat back 14 for supporting a head of the occupant. A cable assembly 32, often referred to as a Bowden cable, is provided connected to the seat back 14 and the head restraint assembly 28 for extending the head restraint to an extended position illustrated in FIG. 1 when the seat back 14 is in an upright position. The head restraint assembly 28 operates to retract the head restraint 30 when the seat back 14 is in a folded position.

The head restraint assembly 28 includes a pair of guide sleeves 34, 36 mounted to the upper crossbar 22. A pair of support rods 38, 40 extends from the guide sleeves 34, 36 for supporting the head restraint 30. The adjustment mechanism of the head restraint assembly 28 is provided in one of the guide sleeves 34. Accordingly, the cable assembly 32 is connected to the guide sleeve 34.

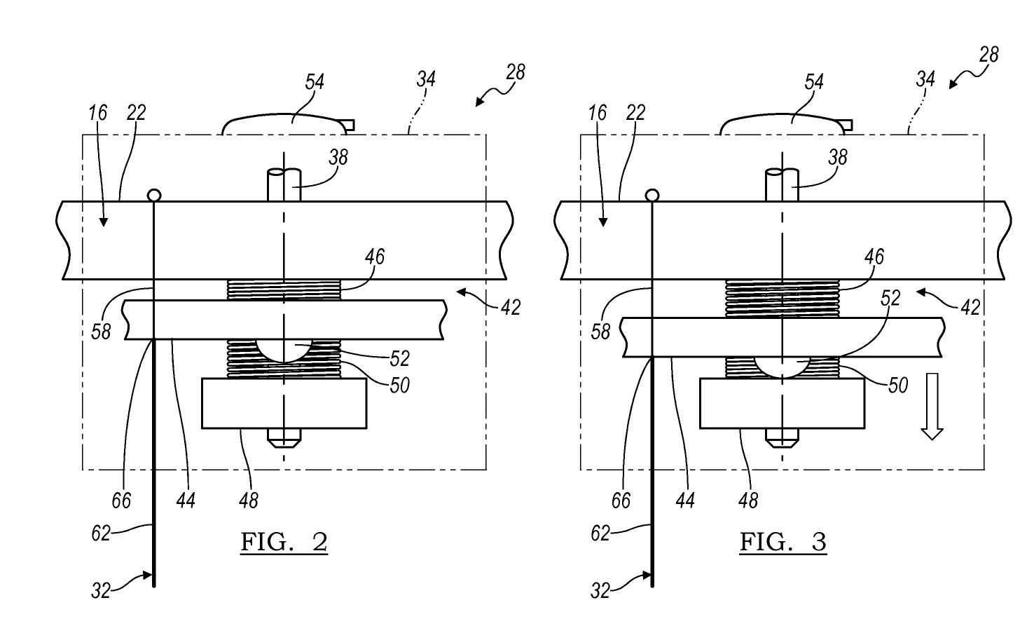

Referring now to FIG. 2, the guide sleeve 34 is illustrated mounted to the upper cross member 22 of the seat back frame 16. The support rod 38 is translatable relative to the guide sleeve 34 for extension and retraction of the head restraint 30. FIG. 1 illustrates the support rod 38 in a fully extended position corresponding to an extended position of the head restraint 30. The support rod 38 is mounted to a suspension 42 within the guide sleeve 34.

A slider 44 is oriented upon the support rod 38 beneath the upper cross member 22 to translate along the support rod 38. A first biasing member, such as a compression spring 46 is provided about the support rod 38 between the upper cross member 22 and the slider 44 for urging the slider 44 downward. Of course, the compression spring 46 could engage a configuration within the guide sleeve 34 instead of the upper cross member 22. A retainer 48 is provided on a distal end of the support rod 38. A second biasing member, such as an extension spring 50 is provided about the support rod 38 between the retainer 48 and the slider 44 for urging the retainer 48 and consequently the support rod 38 toward the slider 44. A hard stop, such as burl 52 is provided between the slider 44 and the retainer 48 for providing clearance for the extension spring 50, preventing a compressive load from being applied to the extension spring 50, and for preloading the extension spring 50. For example, the burl 52 is mounted to the underside of the slider 44.

FIG. 2 illustrates the support rod 38 in the extended position. The support rod 38 is locked due to the cooperation with the cable assembly 32 as will be discussed below. A locking mechanism 54 is provided upon the guide sleeve 34 as is known in the art. Alternatively, the locking mechanism 54 may lock the support rod 38 in the upright position. Referring to FIG. 3, the seat back 14 is in an intermediate position as the seat back 14 is pivoting. The head restraint assembly 28 is unlocked and the compression spring 46 is expanding thereby pressing the slider 44 against the cable assembly 32 thereby retracting the support rod 38 and consequently the head restraint 30. In the alternative embodiment wherein the locking mechanism 54 locks the support rod 38 in the extended position, tilting of the seat back 14 unlocks the locking mechanism 54 for retraction of the support rod 38. The unlocking of the locking mechanism 54 may be provided by a release lever on the seat back 14 as is known in the art.

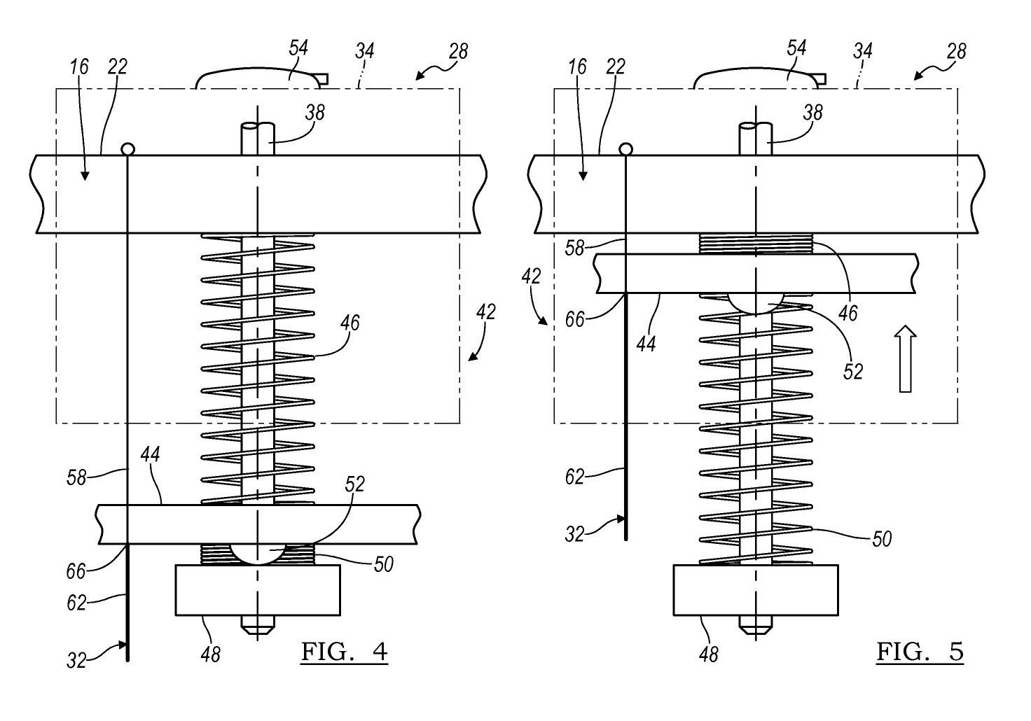

In FIG. 4, the seat back 14 is in the folded position and the compression spring 46 fully extends thereby urging the slider 44 against the cable assembly 32. The locking mechanism 54 cooperates with the support rod 38 for locking the support rod 38 in the retracted position illustrated in FIG. 4. When the seat back 14 is folded to the upright position illustrated in FIG. 5, the cable assembly 32 returns the slider 44 to the upward position. The support rod 38 is still retracted due to the locked position of locking mechanism 54. The extension spring 50 is expanded and under tension. In the upright position of the seat back 14, an occupant can return the head restraint 30 to the extended position by manually actuating the locking mechanism 54 whereby the extension spring 50 returns the retainer 48 into engagement with the burl 52 as illustrated in FIG. 2.

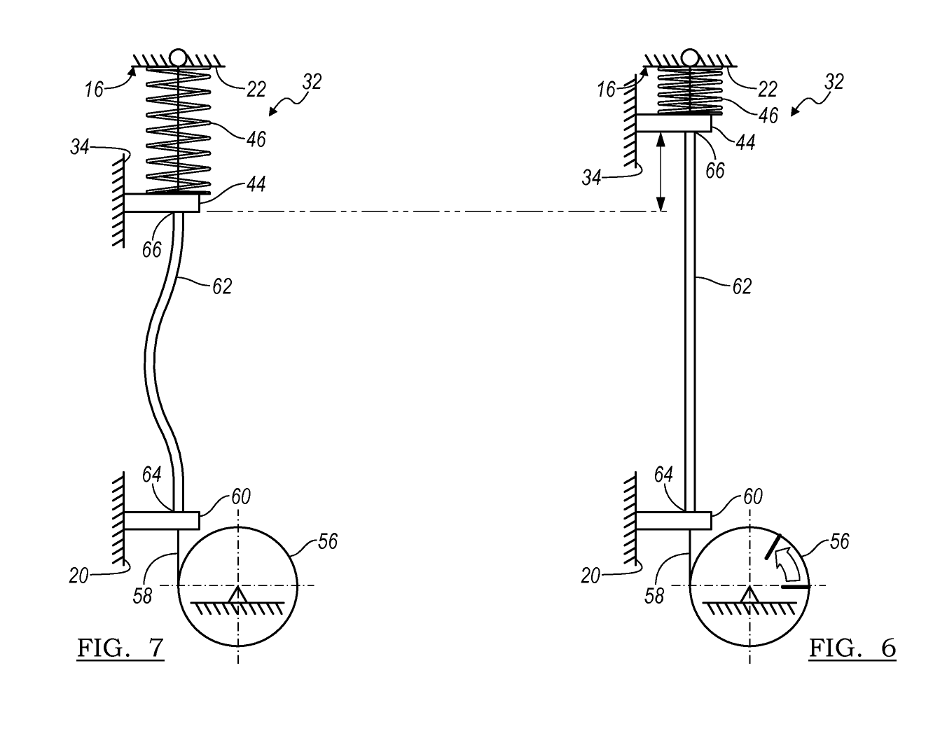

Referring now to FIGS. 6 and 7, the cable assembly 32 is illustrated in greater detail. The cable assembly 32 includes a drum 56 that is fixed relative to the seat back 14. For example, and with reference to FIG. 1, the drum 56 may be mounted to the seat bottom 12 and may be aligned with the pivot axis 26 of the seat back 14. Referring again to FIG. 6 and seven, the cable assembly 32 also includes a cable 58 that is mounted to the drum 56. The cable 58 is wrapped at least partially about the drum 56 and extends through a bushing 60 on the seat back frame 16. The bushing 60 is a fixed location upon the seat back frame 16 is illustrated in FIG. 1. The cable 58 extends through the guide sleeve 34, through the slider 44 and is connected to another fixed location upon the seat back frame 16, such as the upper cross member 22. The connection of the cable 58 to the upper cross member 22 is also illustrated in FIGS. 2-5.

The cable assembly 32 also includes a sheath 62 that is disposed about the cable 58. The sheath 62 is shorter than the cable 58 and has a first end 64 abutting the bushing 60. This engagement of the sheath first end 64 and the bushing 60 is illustrated in FIGS. 1, 6 and 7. The sheath 62 extends into the guide sleeve 34; and has a second end 66 that abuts the slider 44. The engagement of the sheath second end 66 with the slider 44 is illustrated in FIGS. 2-7.

With reference specifically the FIGS. 6 and 7, the operation of the cable assembly 32 is depicted. When the seat back 14 is in the upright position as depicted in FIG. 6, the cable 58 is wrapped about the drum 56 such that the cable 58 is under tension. With the cable 58 under tension, the sheath 62 is aligned linearly with the cable 58 and is thereby pressed against the bushing 60 and the slider 44 under compression, which in turn forces the slider 44 against the compression spring 46 thereby compressing the compression spring 46. This function along may lock the support rod 38, and consequently the head restraint 30 in the locked position of FIG. 2. As discussed above, the locking mechanism 54 may be employed to lock the support rod 38 in the upright position.

As the seat back 14 is folded, the seat back 14 is pivoted about the pivot axis 26. The pivoting of the seat back 14 changes the radial position of the bushing 60 relative to the drum 56 as depicted in FIG. 7. Consequently, less length of the cable 58 is wrapped about the drum 56, thereby providing slack to cable 58. The slack removes the tension from the cable 58, thereby removing compression from the sheath 62. With the sheath 62 no longer under compression, the force exerted upon the slider 44 is removed. Accordingly, the compression spring 46 extends the slider 44 downward. The length of the cable 58 unwrapped from the drum 56 corresponds to the length of displacement of the slider 44. As the slider 44 is translated downward from FIGS. 6 to 7, the support rod 38 is also translated downward as illustrated in FIGS. 2 to 4.

As the seat back 14 is returned to the upright position of FIG. 6, the slack of the cable 58 is taken up by the drum 56 thereby tensioning the cable 58, compressing the sheath 62, pressing the slider 44 toward the upper cross member 22 and compressing the compression spring 46 as depicted in FIG. 6. Referring again to FIG. 5, this return of the seat back 14 returns the slider 44, however the support rod 38 is locked in the retracted position by the locking mechanism 54. With the extension spring 50 under tension, manual release of a locking mechanism 54 will return the support rod 38, and consequently the head restraint 30 to the extended position.

The adjustable head restraint assembly 28 permits no additional handling of the head restraint 30 when folding the seat back 14. Therefore, a user may employ a single hand for folding the seat back 14, while concurrently retracting the head restraint 30. Additionally, when the seat back 14 is returned to the upright position, the head restraint 30 is not automatically extended. By leaving the head restraint 30 in the retracted position when the seat back 14 is upright, the head restraint 30 does not unnecessarily block a rear view of a driver when the seat 10 is unoccupied. An occupant can merely depress the locking mechanism 54 for returning the head restraint 30 to the extended position.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An adjustable head restraint assembly comprising:
a guide adapted to be mounted to a seat back frame of a vehicle seat;
a head restraint extending from the seat back and mounted to the guide for translation along the guide;
a suspension cooperating with the guide and the head restraint for biasing the head restraint to an extended position; and
a locking mechanism for maintaining the head restraint in a retracted position.

2. The adjustable head restraint assembly of claim 1 wherein the head restraint comprises at least one support rod; and
wherein the guide comprises a guide sleeve adapted to receive the at least one support rod for translation of the at least one support rod within the guide sleeve, the guide sleeve being adapted to be affixed to an upper cross member of the seat back frame.

3. The adjustable head restraint assembly of claim 2 wherein the locking mechanism is oriented upon the guide sleeve.

4. The adjustable head restraint assembly of claim 2 further comprising a slider oriented upon the at least one rod for translation therealong.

5. The adjustable head restraint assembly of claim 4 wherein the suspension comprises a biasing member for cooperating with the slider and one of the guide sleeve and the upper cross member of the seat back frame for biasing the slider away from the one of the guide sleeve and the upper cross member for retracting the head restraint.

6. The adjustable head restraint assembly of claim 5 wherein the biasing member comprises a compression spring oriented about the at least one rod for engaging the slider and one of the guide sleeve and the upper cross member of the seat back frame.

7. The adjustable head restraint assembly of claim 4 wherein the suspension comprises:
a retainer mounted on the at least one support rod spaced apart from the head restraint with the slider therebetween; and
a biasing member for cooperating with the slider and the retainer for biasing the slider towards the retainer for extending the head restraint.

8. The adjustable head restraint assembly of claim 7 wherein the biasing member comprises an extension spring oriented about the at least one rod for engaging the slider and the retainer.

9. A vehicle seat comprising:
a seat bottom;
a seat back mounted to pivot relative to the seat bottom between an upright position and a folded position, the seat back comprising a frame; and
an adjustable head restraint assembly according to claim 1 wherein the guide is mounted to the seat back frame.

10. The vehicle seat of claim 9 wherein the head restraint comprises at least one support rod;
wherein the guide comprises a guide sleeve adapted to receive the at least one support rod for translation of the at least one support rod within the guide sleeve, the guide sleeve being adapted to be affixed to an upper cross member of the seat back frame;
wherein the adjustable head restraint assembly further comprises a slider oriented upon the at least one rod for translation therealong;
wherein the suspension comprises a biasing member for cooperating with the slider and the upper cross member of the seat back frame for biasing the slider away from the upper cross member for retracting the head restraint; and
wherein the vehicle seat further comprises a cable assembly cooperating with the seat back for overcoming the bias of the biasing member in the upright position for extending the head restraint to an extended position.

11. An adjustable head restraint assembly comprising:
a guide sleeve adapted to be affixed to an upper cross member of a seat back frame of a vehicle seat;
at least one support rod extending from the guide and mounted to the guide to translate along the guide;
a head restraint mounted to the at least one support rod;
a slider mounted to translate along the at least one support rod;
a first biasing member for cooperating with the slider and one of the guide sleeve and the seat back frame for retracting the head restraint relative to the seat back frame; and
a second biasing member cooperating with the at least one support rod and the slider for extending the head restraint relative to the seat back frame.

12. The adjustable head restraint assembly of claim 11 further comprising a locking mechanism oriented upon the guide sleeve and cooperating with the at least one support rod for maintaining the head restraint in a retracted position.

13. The adjustable head restraint assembly of claim 11 wherein the first biasing member comprises a compression spring oriented about the at least one rod for engaging the slider and one of the guide sleeve and the upper cross member of the seat back frame.

14. The adjustable head restraint assembly of claim 11 further comprising a retainer mounted on the at least one support rod spaced apart from the head restraint with the slider therebetween, wherein the second biasing member cooperates with the slider and the retainer for biasing the slider towards the retainer for extending the head restraint.

15. The adjustable head restraint assembly of claim 14 wherein the second biasing member comprises an extension spring oriented about the at least one rod for engaging the slider and the retainer.

16. The adjustable head restraint assembly of claim 15 further comprising a hard stop oriented upon one of the slider and the retainer facing the other of the slider of the retainer for preventing contact of the slider and retainer and maintaining a preload upon the extension spring.

17. A vehicle seat comprising:
a seat bottom;
a seat back mounted to pivot relative to the seat bottom between an upright position and a folded position, the seat back comprising a frame; and
an adjustable head restraint assembly according to claim 11 wherein the guide sleeve is mounted to the seat back frame.

18. The vehicle seat of claim 17 further comprising a cable assembly cooperating with the seat back for overcoming the bias of the first biasing member in the upright position for extending the head restraint to an extended position.

19. A vehicle seat comprising:
a seat bottom;
a seat back mounted to pivot relative to the seat bottom between an upright position and a folded position, the seat back comprising a frame;
a guide mounted to the seat back frame;
a head restraint extending from the seat back and mounted to the guide for translation along the guide;
a suspension cooperating with the guide and the head restraint for biasing the head restraint to a retracted position;
a cable assembly cooperating with the seat back for overcoming the bias of the suspension in the upright position for extending the head restraint to an extended position; and
a locking mechanism for maintaining the head restraint in the retracted position.

20. The vehicle seat of claim 19 wherein the cable assembly comprises:
a drum affixed relative to the seat bottom;
a cable mounted to the drum, extending around the drum, through a first fixed location upon the seat back frame, through the slider, and connected to a second fixed location upon the seat back frame; and
a sheath disposed about the cable between and contacting the first fixed location upon the seat back frame and the slider such that in the upright orientation of the seat back frame, the cable is wrapped about the drum in tension from the drum to the second fixed location thereby extending the sheath under compression and consequently translating the slider toward the upper cross member against the bias of the biasing member, and in the folded position of the seat back frame, the cable is slackened from the drum thereby permitting the biasing member to retract the head restraint.
